(19) United States
(12) Patent Application Publication
(10) Pub. No.: US 2017/0161713 A1
(43) Pub. Date: Jun. 8, 2017

(54) SELECTING AN ELECTRONIC PAYMENT ACCOUNT TO MAXIMIZE REWARDS

(71) Applicant: International Business Machines Corporation, Armonk, NY (US)

(72) Inventors: Yucong Feng, Austin, TX (US); Su Liu, Austin, TX (US); Andrew F. Ly, Austin, TX (US); Michael S. Ly, Austin, TX (US)

(21) Appl. No.: 14/961,965

(22) Filed: Dec. 8, 2015

(51) Int. Cl. G06Q 20/22; G06Q 20/32; G06Q 20/36; G06Q 30/02

(52) U.S. Cl. CPC G06Q 20/227; G06Q 30/0226; G06Q 20/32; G06Q 20/363

(57) ABSTRACT

Embodiments of the present invention may disclose a method, system, and computer program product for selecting a combination of accounts of a user on a payment platform for a transaction. A computing device may receive transaction data comprising electronic data associated with one or more products and electronic data associated with a retailer. The computing device may transmit a rewards inquiry to a set of rewards provider servers. The rewards inquiry may include an electronic request for rewards data associated with one or more accounts of the user. The computing device may receive rewards data from the set of rewards provider servers. The computing device may map the transaction data in a transaction database with the rewards data in a rewards database. The computing device may select a combination of accounts to purchase the one or more products to maximize total rewards based on the mapping.

### BACKGROUND

The present invention relates generally to an electronic payment system, and more particularly to selecting an electronic payment account to maximize rewards.

Mobile devices capable of storing electronic payment accounts (e.g., credit cards, bank cards, debit cards, etc.) have been widely used. Payment terminals capable of processing electronic payment transactions using various mobile payment platforms have begun to emerge. With the emergence of such payment terminals, users may have options in selecting which of their electronic payment accounts may be used in completing a transaction with the merchant.

### SUMMARY

Embodiments of the present invention disclose a method for managing data communications on an electronic device. The method may include receiving, by the electronic device, data associated with a transaction. The method may include determining availability of a network connection. In response to determining the network connection is available, the method may include querying a set of servers associated with corresponding account information stored on the electronic device and receiving rewards rules data from at least one server in the set of servers. The method may include generating a data model based on applying the rewards rules to the transaction data. The method may include selecting a combination of accounts stored on the electronic device to maximize a value of total rewards based on the data model. In response to determining the network connection is unavailable, the method may include querying a local database storing rewards rules data and receiving rewards rules data from the local database. The method may include periodically querying the set of servers associated with corresponding account information stored on the electronic device, receiving rewards rules data from at least one server in the set of servers, and updating a local database storing rewards rules data.

Embodiments of the present invention disclose a computer program product for managing data communications on an electronic device. The computer program product may include a computer readable storage medium having program instructions embodied therewith. The computer readable storage medium is not a transitory signal per se. The program instructions may be executable by a computer to cause the computer to perform a method. The method may include receiving, by the electronic device, data associated with a transaction. The method may include determining, by the electronic device, availability of a network connection. In response to determining the network connection is available, the method may include querying a set of servers associated with corresponding account information stored on the electronic device and receiving rewards rules data from at least one server in the set of servers. The method may include generating, by the electronic device, a data model based on applying the rewards rules to the transaction data. The method may include selecting, by the electronic device, a combination of accounts stored on the electronic device to maximize a value of total rewards based on the data model.

Embodiments of the present invention disclose a computer system for managing data communications on an electronic device. The computer system may include one or more computer processors, one or more computer-readable storage media, and program instructions stored on the computer-readable storage media for execution by at least one of the one or more processors. The program instructions may include instructions to receive, by the electronic device, data associated with a transaction. The program instructions may include instructions to determine availability of a network connection. In response to determining the network connection is available, the program instructions may include instructions to query a set of servers associated with corresponding account information stored on the electronic device and receive rewards rules data from at least one server in the set of servers. The program instructions may include instructions to generate a data model based on applying the rewards rules to the transaction data. The program instructions may include instructions to select a combination of accounts stored on the electronic device to maximize a value of total rewards based on the data model.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings.

FIGS. 1A-1C are illustrations of an electronic payment selection system, in accordance with an embodiment of the present invention.

FIGS. 2A-2B are illustrations of a payment platform on a computing device, in accordance with an embodiment of the present invention.

FIG. 3 is a flowchart depicting operational steps of an account selection program, in accordance with an embodiment of the present invention.

FIG. 4 depicts a block diagram of components of a proxy server computer executing the account selection program, in accordance with an embodiment of the present invention.

FIG. 5 is a schematic of a cloud computing environment, in accordance with an embodiment of the present invention.

FIG. 6 is a set of abstraction layers provided by the cloud computing environment, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

The present invention relates generally to an electronic payment system, and more particularly to selecting an electronic payment account to maximize rewards. Mobile devices capable of storing electronic payment accounts (e.g., credit cards, bank cards, debit cards, etc.) have been widely used. Payment terminals capable of processing electronic payment transactions using various mobile payment platforms have begun to emerge. With the emergence of such payment terminals, users may have options in selecting which of their electronic payment accounts may be used in completing a transaction with the merchant. However, conventional mobile payment platforms may not include rewards information associated with an electronic payment account or identify an electronic payment account which may maximize rewards.

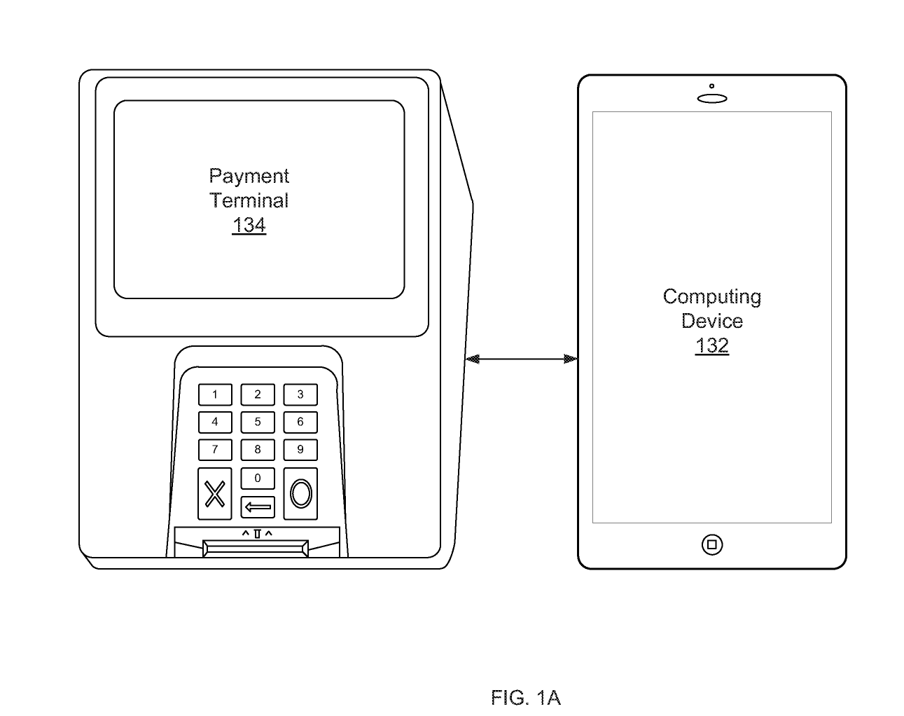

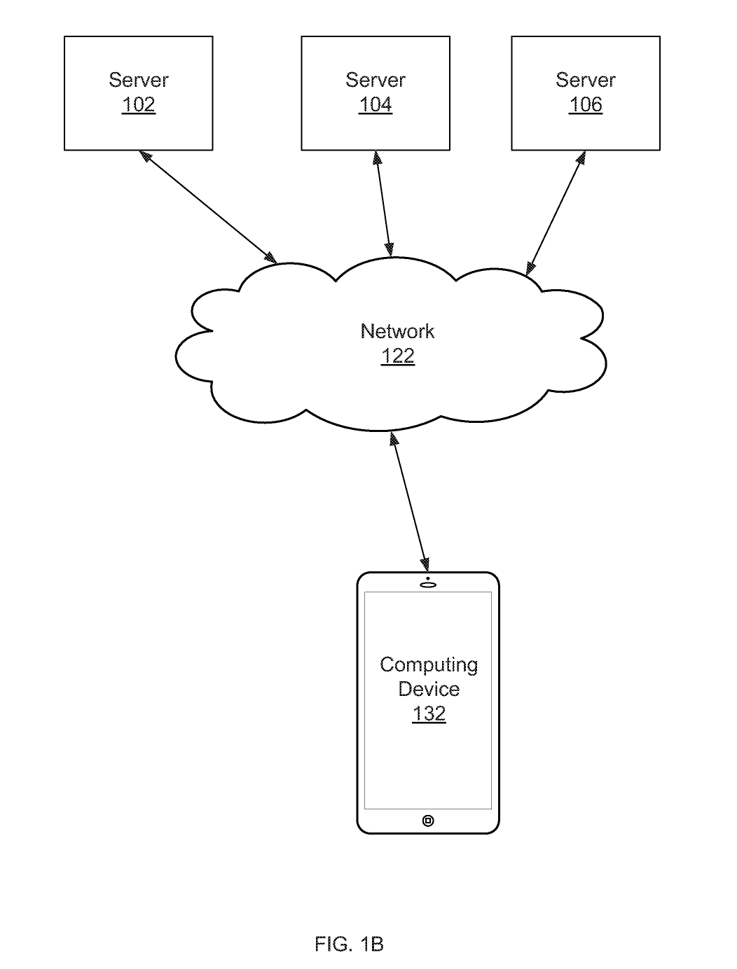

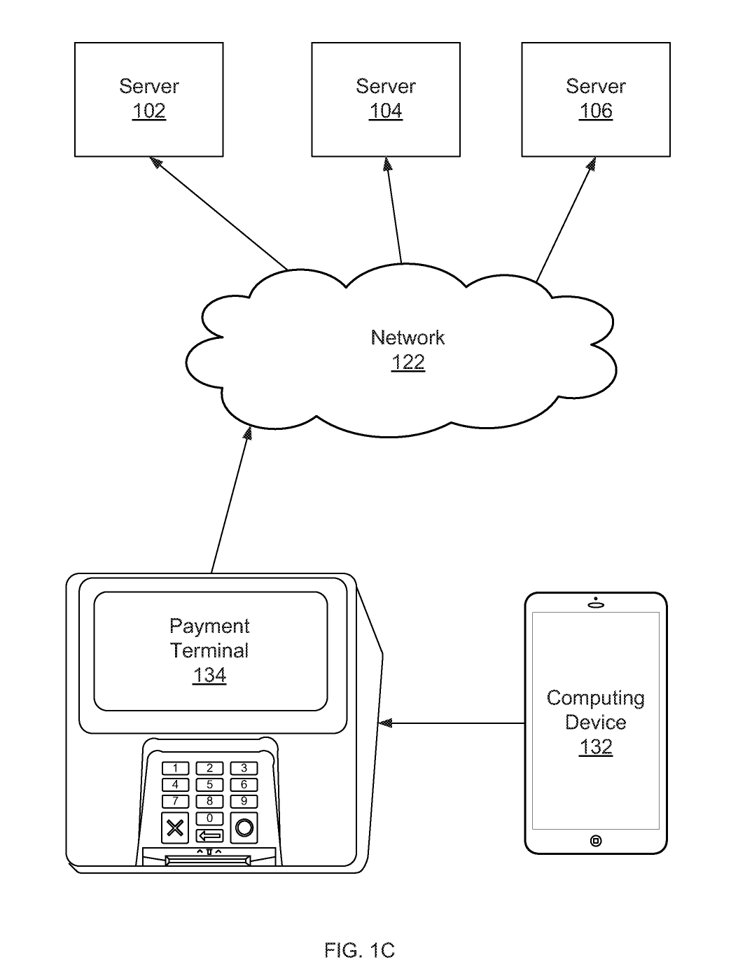

Embodiments of the present invention may include rewards information associated with an electronic payment account and identify an electronic payment account which may maximize rewards for a user. Embodiments of the present invention will now be described in detail with reference to FIGS. 1A-6.

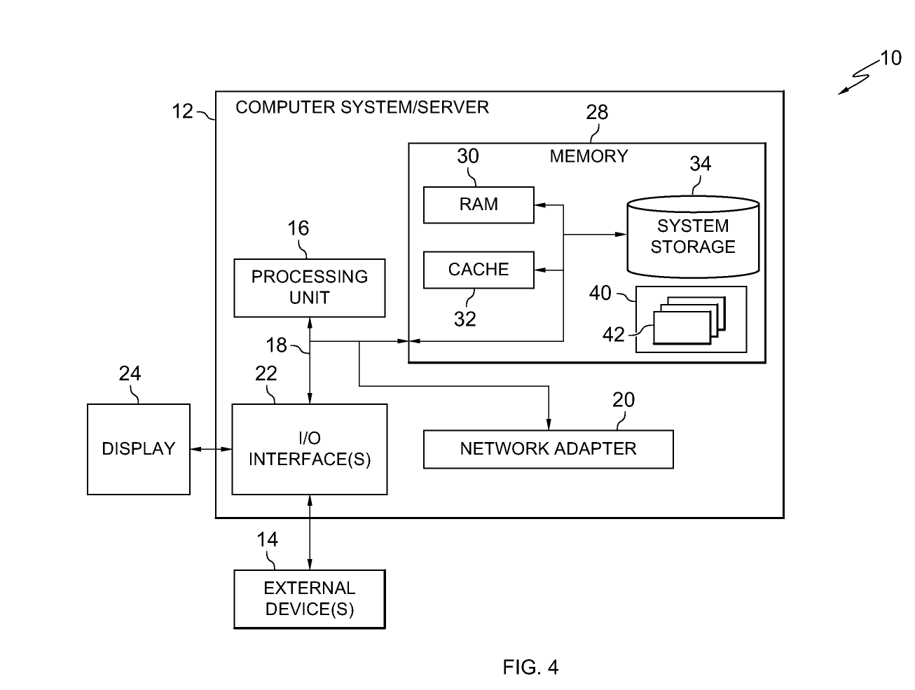

FIGS. 1A-1C are illustrations of an electronic payment selection system 100, according to an aspect of the invention. In an embodiment, the electronic payment selection system 100 may include a set of rewards provider servers, a network 122, a computing device 132, and a payment terminal 134. In another embodiment, the electronic payment selection system 100 may include the network 122, the computing device 132, and one or more commodities (e.g., products and/or services). In an embodiment, electronic payment selection system 100 may include an electronic payment account selection application (hereinafter “account selection application” or “account selection program”). The account selection application may be a program, function, or module of a computer program (not shown) executable by a processor of the electronic payment selection system 100. The electronic payment selection system 100 may be implemented using a computing node such as the cloud computing node of FIG. 4. It is not necessary that the computing node described in FIG. 4 be a cloud computing node and may be, instead, implemented using a general purpose computer.

Computing device 132 may be a laptop computer, tablet computer, netbook computer, personal computer (PC), desktop computer, smart phone, or any programmable electronic device. Computer device 132 may include internal and external hardware components, as depicted and described in further detail with respect to FIG. 4. Computing device 132 may include the account selection application. Computing device 132 may include any communication device known in the art, such as, for example, a Bluetooth device, WiFi device, near-field communication (NFC) device, radio frequency device, or any combination thereof. For example, the computing device may include a barcode reader and an NFC reader to receive information from one or more commodities and a WiFi device and a LTE device to communication with the network 122. The computing device 132 may include one or more databases, such as, for example, a transaction database, a rewards database, or any combination thereof.

The payment terminal 134 may be a device capable of interfacing with a payment device, such as, for example, the computing device 132. In an embodiment, the payment terminal 134 may include any communication device known in the art, such as, for example, near-field communication (NFC) device, a Bluetooth device, WiFi device, radio frequency device, or any combination thereof. For example, the payment terminal 134 may include an NFC device capable of communicating with the computing device 132 to make an electronic funds transfer from a selected set of rewards providers to a retailer.

Network 122 may be any combination of connections and protocols that will support communications between the one or more servers and the computing device 132. In an embodiment, network 122 may be the Internet, representing a worldwide collection of networks and gateways to support communications between devices connected to the Internet. Network 122 may include, for example, wired, wireless or fiber optic connections. In other embodiments, network 122 may be implemented as an intranet, a local area network (LAN), a wide area network (WAN), or a combination thereof.

The set of rewards provider servers may include, for example, server 102, server 104, and server 106. The set of rewards provider servers may be operated by a rewards provider, such as, for example, a credit card company or other financial institution. In an embodiment, server 102 may be operated by a first rewards provider, server 104 may be operated by a second rewards provider, and server 106 may be operated by a third rewards provider. The set of rewards provider servers may comprise an input/output (I/O) interface to enable communications with external devices. For example, the I/O interface may enable communications with the computing device 132 and/or the payment terminal 134 via the network 122. In an embodiment, the set of rewards provider servers may include rewards data associated with a user of the electronic payment selection system 100. In an embodiment, the set of rewards provider servers may have access to rewards data associated with a user of the electronic payment selection system 100.

Referring now to FIG. 1A, an illustration of the computing device 132 receiving transaction data from the payment terminal 134 is shown, according to an aspect of the invention. In an embodiment, the computing device 132 may receive transaction data comprising electronic data associated with one or more commodities and electronic data associated with a retailer. The transaction data may be received via any electronic communication method known in the art, such as, for example, a wired connection, a wireless connection, or any combination thereof. For example, a user of the computing device 132 in a retail store may hold the computing device 132 (e.g. a cellular phone) within a proximity of the payment terminal 134 so the computing device 132 may receive the transaction data via NFC communication. In another example, a user of the computing device 132 in an online store may direct the computing device 132 (e.g. a desktop computer) to request transaction data from the payment terminal 134 (e.g. a server for the online store) and receive the transaction data via the internet. The computing device 132 may store the transaction data in a transaction database.

In another embodiment, the computing device 132 may receive transaction data from one or more commodities directly (i.e. without using the payment terminal 134). One or more commodities may include one or more communication devices, such as, for example, a barcode, NFC chip, or a combination thereof. The computing device 132 may receive transaction data from a communication device affixed to one or more commodities. For example, the computing device 132 may detect a barcode affixed to a commodity to receive transaction data related to the commodity. In another example, the computing device 132 may receive transaction data from an NFC chip affixed to a commodity.

In an embodiment, a user of the computing device 132 may direct the computing device 132 to receive data from one or more commodities that the user intends to purchase. For example, a user may want to purchase a hammer, hardwood floor installation, and an air conditioning unit from a hardware store. The user may hold the computing device 132 in a position such that the computing device can detect a barcode on the hammer, a card with a barcode on a purchase form for the hardwood floor installation, and a barcode on the air conditioning unit so the computing device may receive transaction data. In another example, the user may hold the computing device 132 near an NFC chip on the hammer, a card with an NFC chip on a purchase form for the hardwood floor installation, and an NFC chip on the air conditioning unit so the computing device 132 may receive transaction data.

Referring now to FIG. 1B, an illustration of the computing device 132 receiving rewards data from a set of rewards provider servers is shown, according to an aspect of the invention. In an embodiment, the computing device 132 may check for an available network connection to communicate with the set of rewards provider servers. For example, the computing device 132 may check if WiFi, LTE, and/or another network connection is available. The computing device 132 may communicate with the set of rewards provider servers via the network 122. The computing device 132 may transmit a rewards inquiry to the set of rewards provider servers with a rewards inquiry. The rewards inquiry may include an electronic request for rewards data associated with one or more accounts of the user. For example, the computing device 132 may transmit a first rewards inquiry to the server 102, a second rewards inquiry to the server 104, and a third rewards inquiry to the server 108. The set of rewards provider servers may include a database with rewards data associated with one or more accounts of the user and/or may have access to a database with rewards data associated with one or more accounts of the user. The set of rewards provider servers may transmit the rewards data associated with one or more accounts of the user to the computing device 132 via the network 122. The computing device 132 may receive the rewards data associated with one or more accounts of the user from the set of rewards provider servers. The computing device 132 may store the rewards data in a rewards database.

In an embodiment, the computing device 132 may map the transaction data in a transaction database with the rewards data in the rewards database. Mapping the transaction data with the rewards data may permit the computing device 132 to determine a maximum total rewards available from one or more accounts with one or more rewards providers for the purchase of the one or more commodities in the transaction. Mapping may involve associating a set of rewards with the one or more commodities. An account may be associated with each reward. By mapping the transaction data with the rewards data, the computing device 132 may determine which rewards are available for the one or more commodities in the transaction.

In an embodiment, the computing device 132 may determine a maximum value for available rewards. A value may be determined for each reward. For example, one frequent flyer mile may be assigned a monetary value equivalent to an average cost of flying one mile for all flyers in a prior time frame (e.g., average flight mile cost for all flyers in the past year). In another example, one frequent flyer mile may be assigned a monetary value equivalent to an average cost of flying one mile for the user in a prior time frame (e.g., average flight mile cost for the user in the past year). Various combinations of the one or more commodities purchased with the one or more accounts to earn one or more rewards may be calculated. A maximum reward may be determined by identifying the combination of the one or more commodities purchased with the one or more accounts that produces a greatest total rewards.

Referring now to FIG. 1C, an illustration of the computing device 132 transmitting data associated with a selected combination of accounts to the payment terminal 134 is shown, according to an aspect of the invention. In an embodiment, the computing device 132 may transmit data associated with the selected combination of accounts at a retail store. For example, a user of the computing device 132 in a retail store may hold the computing device 132 (e.g. a cellular phone) within a proximity of the payment terminal 134 so the computing device 132 may transmit data associated with the selected combination of accounts via NFC communication. In an embodiment, the computing device 132 may transmit data associated with the selected combination of accounts via the internet (e.g., to checkout at an online store). For example, a user of the computing device 132 in an online store may direct the computing device 132 (e.g. a desktop computer) to transmit data associated with the selected combination of accounts to the payment terminal 134 (e.g. a server for the online store) via the internet.

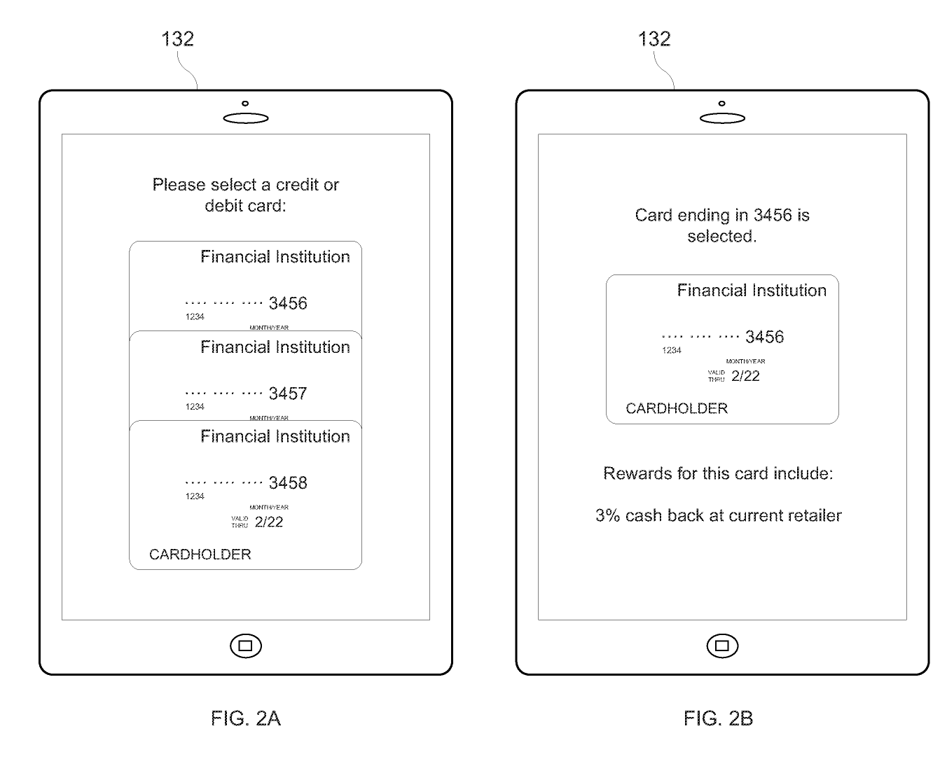

Referring now to FIGS. 2A-2B, illustrations of a payment platform on a computing device are shown, in accordance with an embodiment of the present invention. The payment platform may be a program, function, or module of a computer program (not shown) executable by a processor of the electronic payment selection system 100 (FIG. 1). The payment platform may use a software as a service (SaaS) based methodology to connect a disparate group of international payment systems. The payment platform may enable communications between, for example, the computing device 130 and a set of rewards provider servers. Communications may be governed by a standard application programming interface (API). The payment platform may provide a single interface to a user of the computing device 132 to access an electronic wallet.

FIG. 2A illustrates a first payment platform provided as a single interface to a user of the computing device 132 without the account selection application. The first payment platform may include data associated with one or more accounts including, for example, a credit card account, checking account, savings account, health savings account, or another account. For example, the first payment platform may include data associated with a first credit card 3456, a second credit card 3457, and a third credit card 3458. The first payment platform may not include data associated with rewards since it lacks the account selection application. The first payment platform may not select an account for payment in a transaction since it lacks the account selection application.

FIG. 2B illustrates a second payment platform provided as a single interface to a user of the computing device 132 with the account selection application. The second payment platform may include data associated with one or more accounts including, for example, a credit card account, checking account, savings account, health savings account, or another account. For example, the second payment platform may include data associated with a first credit card 3456, a second credit card 3457, and a third credit card 3458.

The second payment platform may include rewards data associated with one or more accounts since it includes the account selection application. The account selection application may transmit a rewards inquiry to a set of rewards provider servers. The account selection application may receive rewards data from the set of rewards provider servers to update a rewards database. The rewards database may be updated periodically, for example, weekly or daily. The rewards database may be updated at a time of a transaction so that real time rewards data may be used to determine a maximum total rewards available for a transaction. If a time of transaction rewards data update is unavailable, rewards data from a last update of a rewards database may be used to determine a maximum total rewards available for a transaction.

The second payment platform may display a selected account for payment in a transaction since the second payment platform includes the account selection application. For example, the account selection application may map transaction data with rewards data. The account selection application may calculate a maximum total rewards available for the transaction based on the mapped transaction data with rewards data. The account selection application may select the combination of accounts to purchase one or more commodities that maximizes rewards available from the accounts stored in the payment platform. In an embodiment, the account selection application may provide the selected combination of accounts to the payment terminal. For example, by transmitting the selected combination of accounts to the payment terminal by NFC. In an embodiment, the account selection application may provide the selected combination of accounts to the payment platform application. For example, by providing the selected combination of accounts to the payment platform application so the payment platform application may display the selected combination of accounts on the computing device 132.

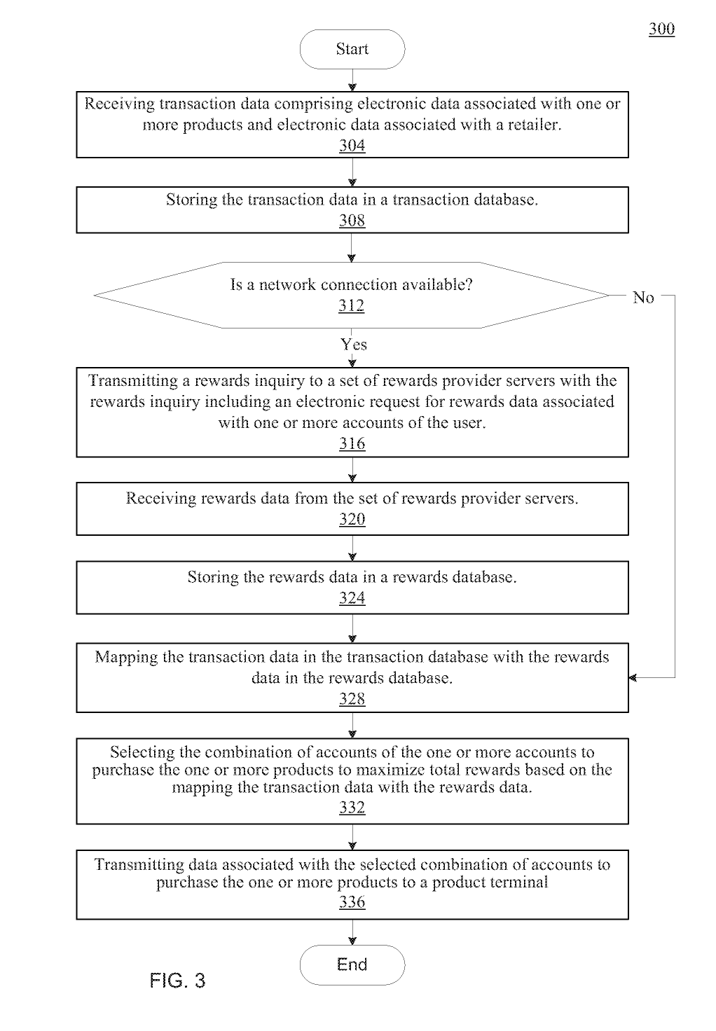

FIG. 3 is a flowchart of a method 300 for selecting a combination of accounts of a user on a payment platform, using the electronic payment selection system 100 of FIG. 1, in accordance with an embodiment of the present invention. Steps of method 200 may be executed using a processor of a computer that encompasses, or is part of, electronic payment selection system 100, or another system. In an embodiment, a method of selecting a combination of accounts of a user on a payment platform may involve receiving transaction data comprising electronic data associated with one or more commodities and electronic data associated with a retailer (step 304), storing the transaction data in a transaction database (step 308), determining whether a network connection is available (decision 312), transmitting a rewards inquiry to a set of rewards provider servers, wherein the rewards inquiry comprises an electronic request for rewards data associated with one or more accounts of the user (step 316), receiving rewards data from the set of rewards provider servers (step 320), storing the rewards data in a rewards database (step 324), mapping the transaction data in the transaction database with the rewards data in the rewards database (step 328), identifying the combination of accounts of the one or more accounts to purchase the one or more commodities to maximize total rewards based on the mapping the transaction data with the rewards data (step 332), and transmitting data associated with the selected combination of accounts to purchase the one or more commodities to a payment terminal (step 336).

Step 304 may involve receiving transaction data. The transaction data may include any data associated with a transaction, such as, for example, electronic data associated with a commodity, a retailer, a customer (e.g. the user), a sales representative, a payment terminal, or any combination thereof. Electronic data associated with a commodity may include, for example, a name of a commodities, a price of a commodities, a type of commodities (e.g., food, clothing, fuel, pharmaceutical, music, movie, video game, service, etc.), commodity characteristics (e.g., size, weight, nutritional information, etc.), a quantity of a commodity (e.g., number of pills in a prescription refill), or any combination thereof. Electronic data associated with a retailer may include, for example, a name of the retailer, a location of a retailer's store, a type of retail store (e.g. grocery, pharmacy, warehouse, etc.), payment methods accepted by the retailer, rewards offered by the retailer, or any combination thereof. Electronic data associated with a customer may include, for example, a name of a customer, prior purchases of a customer, other identifying customer information (e.g. address, phone number, etc.), or any combination thereof.

In an embodiment, the transaction information may be transmitted by a payment terminal (e.g. the payment terminal 134) and received by a user device (e.g. the computing device 132). For example, the computing device 132 may be a cellular phone within a proximity of the payment terminal 134 and receive the transaction information via NFC. In another example, the computing device 132 may be a laptop computer not within a proximity of the payment terminal 134 and receive the transaction information via the internet.

Step 308 may involve storing the transaction data in a transaction database. In an embodiment a user device (e.g. the computing device 132) may store transaction data in a transaction database. For example, the computing device 132 may store the transaction data in a transaction database in a local memory device. In an example, the computing device 132 may store the transaction data in a transaction database in a remote memory device (e.g. a memory device in a cloud computing node). In an example, the computing device 132 may be a cloud computing node and store the transaction data in a local memory device.

Decision 312 may involve determining whether a network connection is available. In an embodiment, a network connection may include, for example, any wired and/or wireless connection to a network (e.g., the network 122) by a user device (e.g., the computing device 132). For example, the computing device 132 may detect an internet connection via an Ethernet cable connected to the computing device 132. In an example, the computing device 132 may detect LTE service providing an internet connection. In an embodiment, determining whether a network connection is available may include evaluating a quality of a network connection. For example, a poor quality network connection requiring substantial time to upload and/or download electronic data may be determined to be unavailable.

In an embodiment, a network connection may not be available (decision 312, No). In an embodiment, if a network is determined to be unavailable (decision 312, No), mapping the transaction data with the rewards data (step 328) may be performed with most recently updated data in a transaction database and most recently updated data in a rewards database. For example, the rewards database may be updated periodically (e.g. daily, weekly, etc.). Although a real time rewards update may not be possible due to an unavailable connection, rewards data in a rewards database from a prior update (e.g. from a day earlier) may be used to perform the mapping of step 328, discussed below.

In an embodiment, a network connection may be available (decision 312, Yes). In an embodiment, if a network connection is determined to be available (decision 312, Yes), a rewards inquiry may be transmitted (step 316), rewards data may be received (step 320), and the received rewards data may be stored in a rewards database (step 324).

Step 316 may involve transmitting a rewards inquiry to a set of rewards provider servers. In an embodiment, the rewards inquiry may include an electronic request for rewards data associated with one or more accounts of the user. For example, the rewards inquiry may include an electronic request for rewards data associated with a credit card account of the user. The rewards data may include, for example, rewards associated with a purchase of a commodity, rewards associated with a purchase from a retailer, or any combination thereof. In an embodiment, the rewards inquiry may be transmitted to each account saved on a user device (e.g. the computing device 132). For example, the computing device 132 may include one or more credit card accounts, debit card accounts, checking accounts, savings accounts, health savings accounts, or any combination thereof.

Step 320 may involve receiving rewards data from the set of rewards provider servers. In an embodiment, the set of rewards provider servers may transmit rewards data to a user device (e.g. the computing device 132) and the user device may receive the rewards data from each rewards provider server of the set of rewards provider servers. For example, the computing device 132 may receive rewards data from a first credit card server and another credit card server.

Step 324 may involve storing the rewards data in a rewards database. In an embodiment, a user device (e.g., the computing device 132) may save the rewards data in a local rewards database (e.g., in a local memory device). In another embodiment, a user device may save the rewards data in a remote rewards database (e.g., in a memory device in a cloud computing node). In an embodiment, storing the rewards data in a rewards database may update existing rewards data in the rewards database. For example, the rewards data may replace prior rewards data. In an example, the rewards data may be saved without deleting prior rewards data. In an embodiment, the rewards data most recently saved may be used in step 328, discussed below.

Step 328 may involve mapping the transaction data in the transaction database with the rewards data in the rewards database. In an embodiment, mapping the transaction data with the rewards data may include determining a data mapping relationship between a source database table (e.g. a table of the transaction data) and a target database table (e.g. a table of the rewards data). Determining a data mapping relationship may include obtaining attribute values in at least one source database table, and obtaining attribute values in at least one target database table. For example, a value of a transaction attribute (e.g. a name of a commodity) may be obtained from the transaction database and a value of a reward attribute (e.g. 3% cash back for purchasing a commodity) may be obtained from the reward database. Determining a data mapping relationship may include determining whether at least one attribute of the at least one source database table and at least one attribute of the target database table have a potential data mapping relationship therebetween. For example, a transaction attribute may include a name of a commodity (e.g., brand A organic milk) and a reward attribute may include a reward for the commodity (e.g., 3% cash back for brand A organic milk). If at least one attribute of at least one source database table and an attribute of the target database table have a potential data mapping relationship therebetween, a data mapping relationship may be determined between at least one attribute of the at least one source database table and the attribute of the target database table. For example, a transaction attribute including “brand A organic milk” may be mapped to a reward attribute including “3% cash back for brand A organic milk.” Mapping the transaction data in the transaction database with the rewards data in the rewards database may enable available awards for a transaction to be identified.

Step 332 may involve selecting the combination of accounts of the one or more accounts to purchase the one or more commodities to maximize a value of available rewards based on the mapping the transaction data with the rewards data. In an embodiment, the mapping of the transaction data with the rewards data (hereinafter “the mapped transaction rewards”) may be used to calculate a maximum total reward. In an embodiment, the maximum total reward may be calculated by quantifying one or more rewards in the rewards data. For example, a reward for frequent flyer miles may be quantified by determining an average cost per mile of flying for a set of users (e.g., domestic flying passengers, international flying passengers, the user of the computing device 132, etc.) for a period of time (e.g., the past year, the past five years, etc.). In another example, a reward for cash back (e.g., 3% cash back) may be quantified by determining the one or more commodities the reward applies to (e.g., by the mapped transaction rewards), determining the value of the one or more commodities the reward applies to (e.g., by extracting price information from the transaction data), and determining 3% of the value of the applicable commodities.

In an embodiment, calculations of various combinations of purchasing the one or more commodities with one or more accounts to generate one or more rewards may be performed. For example, an expectation-maximization (EM) method may be used to determine a maximum value for one or more rewards available in a transaction. In an embodiment, a combination of accounts for purchasing one or more commodities in a transaction which maximizes a value of the rewards may be selected. For example, a combination of credit cards (e.g., credit card A and credit card B) for purchasing one or more commodities (item 1, item 2, and item 3) may be determined to provide a maximum value of total rewards. In an embodiment, a payment with a first account for one or more commodities and a payment with a second account for one or more commodities may be determined to maximize total reward value. For example, using credit card A to purchase item 1 and item 2 and using credit card B to purchase item 3 may be determined to maximize rewards offered by credit card A and credit card B. In an embodiment, a combination of accounts (e.g. one or more accounts of a user) may be determined to maximize total rewards. For example, if a combination of accounts including a first account to purchase a first set of commodities and a second account to purchase a second set of commodities is determined to maximize total rewards, the combination of accounts including the first account to purchase the first set of commodities and the second account to purchase the second set of commodities may be selected.

Step 336 may involve transmitting data associated with the selected combination of accounts to purchase the one or more commodities to a payment terminal (e.g. the payment terminal 134). In an embodiment, the computing device 134 may transmit the data associated with the selected combination to the payment terminal 134. For example, the computing device 134 may transmit the data to the payment terminal 134 via NFC (e.g. if the computing device 134 and the payment terminal are within a proximity of one another). In an example, the computing device 132 may transmit the data to the payment terminal 134 via the internet (e.g. if a user is shopping at an online store).

Referring now to FIG. 4, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program commodity having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

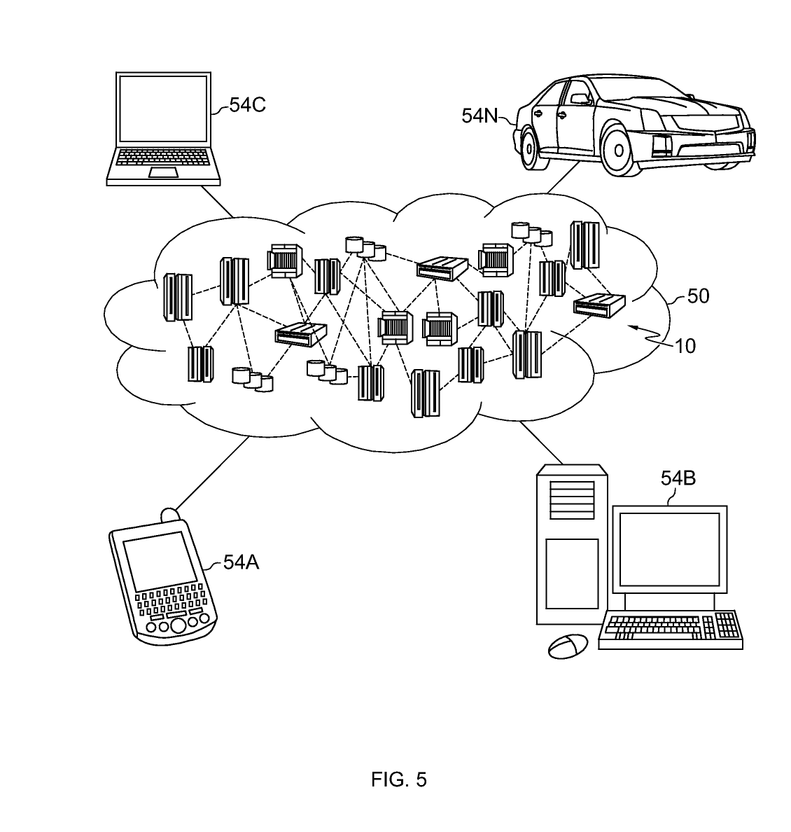

Referring now to FIG. 5, illustrative cloud computing environment 50 is depicted. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

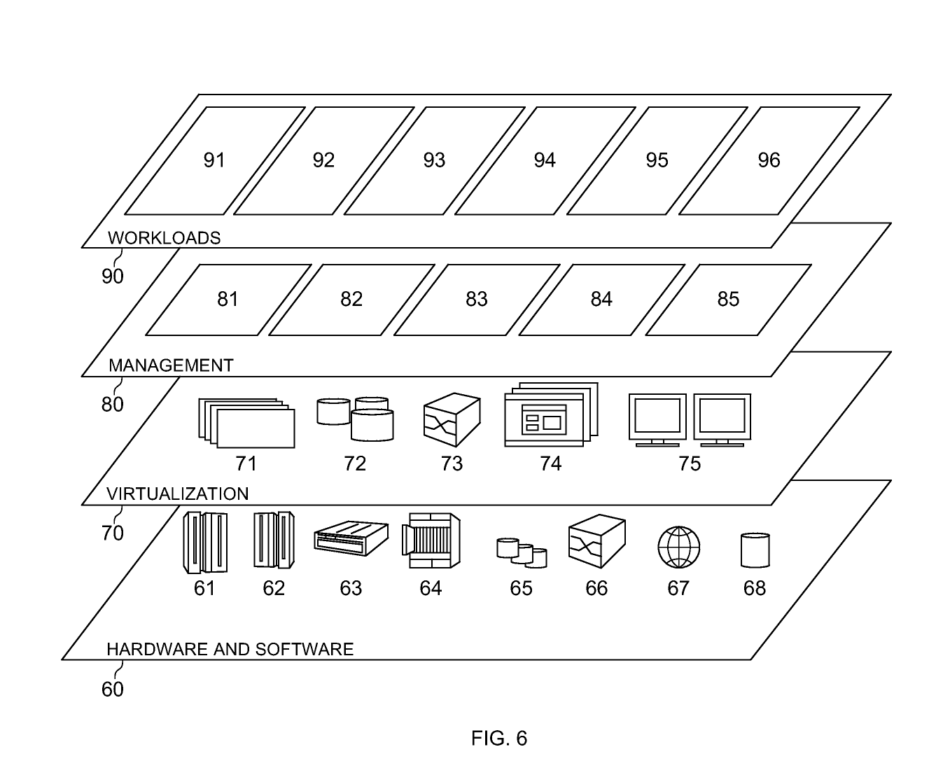

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and selecting a combination of accounts of a user on a payment platform 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A method for managing data communications on an electronic device, comprising:
receiving, by the electronic device, data associated with a transaction;
determining availability of a network connection;
in response to determining the network connection is available, performing the following:
querying a set of servers associated with corresponding account information stored on the electronic device; and
receiving, in response to the querying, rewards rules data from at least one server in the set of servers;
generating a data model based on applying the rewards rules to the data associated with the transaction; and
selecting a combination of accounts stored on the electronic device to maximize a value of available rewards based on the data model.

2. The method of claim 1, further comprising:
in response to determining the network connection is unavailable, performing the following:
querying a local database storing rewards rules data; and
receiving, in response to the querying, rewards rules data from the local database.

3. The method of claim 1, further comprising:
periodically querying the set of servers associated with corresponding account information stored on the electronic device;
receiving, in response to the querying, rewards rules data from the at least one server in the set of servers; and
updating a local database storing rewards rules data.

4. The method of claim 1, further comprising:
transmitting data associated with the selected combination of accounts to a payment terminal.

5. The method of claim 1, wherein the selecting the combination of accounts comprises estimating a value of each reward of the available rewards.

6. The method of claim 1, wherein the combination of accounts comprises a first account for purchasing a first set of commodities and another account for purchasing another set of commodities.

7. The method of claim 1, wherein the combination of accounts comprise one or more of a credit card account, charge card account, debit card account, checking account, savings account, and health savings account.

8. The method of claim 1, wherein the generating the data model based on applying the rewards rules to the data associated with the transaction comprises identifying available awards associated with the transaction.

9. A computer program product for managing data communications on an electronic device, the computer program product comprising a computer readable storage medium having program instructions embodied therewith, wherein the computer readable storage medium is not a transitory signal per se, the program instructions executable by a computer to cause the computer to perform a method comprising:
receiving, by the electronic device, data associated with a transaction;
determining, by the electronic device, availability of a network connection;
in response to determining the network connection is available, performing the following:
querying a set of servers associated with corresponding account information stored on the electronic device; and
receiving, in response to the querying, rewards rules data from at least one server in the set of servers;
generating, by the electronic device, a data model based on applying the rewards rules to the data associated with the transaction; and
selecting, by the electronic device, a combination of accounts stored on the electronic device to maximize a value of available rewards based on the data model.

10. The computer program product of claim 9, further comprising:
transmitting, by the electronic device, data associated with the selected combination of accounts to a payment terminal.

11. The computer program product of claim 9, wherein the selecting, by the electronic device, the combination of accounts comprises estimating a value of each reward of the available rewards.

12. The computer program product of claim 9, wherein the selecting, by the electronic device, the combination of accounts comprises calculating a maximum value of the available rewards.

13. The computer program product of claim 9, wherein the combination of accounts comprises a first account for purchasing a first set of commodities and another account for purchasing another set of commodities.

14. The computer program product of claim 9, wherein the combination of accounts comprise one or more of a credit card account, charge card account, debit card account, checking account, savings account, and health savings account.

15. A computer system for managing data communications on an electronic device, the computer system comprising:
one or more computer processors;
one or more computer-readable storage media;
program instructions stored on the computer-readable storage media for execution by at least one of the one or more processors, the program instructions comprising instructions to:
receive, by the electronic device, data associated with a transaction;
determine availability of a network connection;
in response to determining the network connection is available, perform the following:
query a set of servers associated with corresponding account information stored on the electronic device; and
receive, in response to the querying, rewards rules data from at least one server in the set of servers;
generate a data model based on applying the rewards rules to the data associated with the transaction; and
select a combination of accounts stored on the electronic device to maximize a value of available rewards based on the data model.

16. The system of claim 15, further comprising:
instructions to transmit electronic data associated with the selected combination of accounts to a payment terminal.

17. The system of claim 15, wherein the instructions to select the combination of accounts comprise calculating a maximum value of the available rewards.

18. The system of claim 15, wherein the combination of accounts comprise a first account for purchasing a first set of commodities and another account for purchasing another set of commodities.

19. The system of claim 15, wherein the combination of accounts comprise one or more of a credit card account, charge card account, debit card account, checking account, savings account, and health savings account.

20. The system of claim 15, wherein the instructions to generate the data model based on applying the rewards rules to the data associated with the transaction comprises identifying available awards in the transaction.
